(19) United States
(12) Patent Application Publication
(10) Pub. No.: US 2026/0366341 A1
(43) Pub. Date: Nov. 19, 2026

(54) METHOD FOR OPERATING A MOTOR VEHICLE LOCK WHICH CAN BE ELECTRICALLY ACTUATED BY MEANS OF AN OPENING SIGNAL

(71) Applicant: Kiekert Aktiengesellschaft, Heiligenhaus (DE)

(72) Inventors: Peter SZEGENY, Engelskirchen (DE); Thorsten BENDEL, Oberhausen (DE); Michael HERRMANN, Neukirchen-Vluyn (DE); Johannes BAUER, Wuppertal (DE); Dennis KNUST, Heiligenhaus (DE)

(73) Assignee: Kiekert Aktiengesellschaft, Heiligenhaus (DE)

(21) Appl. No.: 19/515,831

(22) PCT Filed: Aug. 9, 2024
(86) PCT No.: PCT/DE2024/100709

§ 371 Date: Mar. 3, 2026

(30) Foreign Application Priority Data
Sep. 8, 2023 (DE) 102023124248.2

(51) Int. Cl. E05B 81/12; E05B 81/04; E05B 81/70

(52) U.S. Cl. CPC E05B 81/12; E05B 81/04; E05B 81/70

(57) ABSTRACT

A method for operating a motor vehicle lock, which can be electrically actuated by means of an opening signal, includes reversing the motor vehicle lock after an actuation of the motor vehicle lock, the reversing being carried out depending on the opening signal having ceased and/or an ajar signal being received from an ajar device of the motor vehicle lock. A motor vehicle lock operates in accordance with such method.

The invention relates to a method for operating a motor vehicle lock which can be electrically actuated by means of an opening signal, comprising reversing the motor vehicle lock after actuating the motor vehicle lock. The invention further relates to a motor vehicle lock.

It is known to perform reversing with a certain time delay after actuation. In other words, a time-based start signal for reversing is known.

It is also known to perform reversing based on a position of a door element equipped with the motor vehicle lock. In other words, it is known to provide a start signal for reversing based on the door position.

An alternative way is sought to cause the triggering of reversing and/or to perform reversing.

A further problem which automotive manufacturers, as well as suppliers, are continuously dealing with is that of reducing the weight of motor vehicles and the installation space of components to a minimum. The weight of the individual components can minimize the weight of the vehicle overall and thus reduce the consumption of the motor vehicle. A smaller number of components can also lead to weight reduction and, in particular, to a cost reduction which is always desired. This is where the invention comes in.

The object of the invention is to provide an improved method and motor vehicle lock in which reversing can take place reliably in as many situations as possible, as far as possible without increasing the number of components or even while reducing the number of components required. Furthermore, it is an object of the invention to provide a motor vehicle lock having minimal installation space and having the smallest possible number of components, and/or to specify a method for operating such or a similar motor vehicle lock. Moreover, the object of the invention is that of providing a structurally simple and inexpensive solution. Finally, the object of the invention is to specify solutions which avoid or at least substantially reduce the disadvantages of the prior art.

The object is achieved according to the invention by the features of the independent claims. Advantageous embodiments of the invention are specified in the dependent claims. It should be noted that the exemplary embodiments described below are not restrictive; rather, any variation of the features described in the description and the dependent claims is possible.

The object of the invention is achieved by providing a method for operating a motor vehicle lock which can be electrically actuated by means of an opening signal. As proposed, the method comprises (the step) or has (the step): reversing the motor vehicle lock after an actuation of the motor vehicle lock, wherein the reversing is carried out depending on the opening signal having ceased and/or an ajar signal being received from an ajar device of the motor vehicle lock.

In other words, a method is proposed, in particular, which relates to actuating an electric motor vehicle lock, and in which a return movement of an electric drive in the motor vehicle lock undergoes a novel triggering logic.

The novel triggering logic indicates, in particular, that the actuation signal used to actuate the motor vehicle lock can be used to trigger and/or carry out the return movement during or after the signal change from “on” to “off,” i.e., upon cessation of the actuation signal. The novel triggering logic alternatively or additionally indicates that an ajar, or AJAR, signal, which is typically inherent to the motor vehicle lock and/or the motor vehicle equipped with the motor vehicle lock, in particular because it is legally required, can be used to trigger or carry out the return movement upon or after receiving the ajar signal.

The invention has the effect that neither a mere time delay after actuation/actuating to trigger reversing nor a position of the door element needs to be used. Instead, considerably more reliable decision variables are used to trigger reversing. In particular, it is possible to dispense with separately detecting the position of the door, such that, for example, a corresponding detection device, such as a door position sensor for the motor vehicle lock, can be omitted.

The object of the invention is further achieved by providing a motor vehicle lock, comprising a locking mechanism having a catch and a pawl provided for locking the catch in a locked position of the locking mechanism, and an electromechanical drive device which is operatively connected to the locking mechanism and movable, starting from an initial position, to transfer the locking mechanism from the locked position to a release position on the basis of an opening signal, wherein the drive device is designed to reverse to the initial position depending on the opening signal having ceased and/or an ajar signal from the motor vehicle being received.

In particular, it is proposed to monitor an opening signal which is used to actuate an electrically actuatable motor vehicle lock to open a door element of a motor vehicle. The opening signal for triggering reversing of the motor vehicle lock is monitored in such a way that a cessation of the opening signal is considered. Reversing can then be triggered upon and/or after cessation of the opening signal or upon a signal change in the opening signal, e.g., from “on” to “off.” Essentially, use of the opening signal is thus proposed. Analogously, use or monitoring of the ajar signal is proposed to trigger reversing.

In other words, a motor vehicle lock is proposed, in particular, which is designed in such a way that a return movement of an electric drive in the motor vehicle lock can be operated with the novel triggering logic described above.

“Reversing” means, in particular, that the motor vehicle lock is returned to a position or state in which the motor vehicle lock can be actuated again. Reversing takes place, in particular, electrically or electromechanically.

The cessation (or ceasing) of the opening signal is understood, in particular, to mean that the opening signal is no longer received, and/or that the opening signal is no longer present, and/or that the opening signal no longer implies a command to actuate the motor vehicle lock. A cessation means, in particular, a signal change. In this respect, it may be the case that, upon cessation of the opening signal, the opening signal itself, or the medium conveying the opening signal, is still present, but is essentially stripped of the command to actuate the motor vehicle lock. For example, the opening signal can be transmitted via a BUS system, and if the BUS system indicates that “opening is no longer requested,” for example, because a user has released a door handle, it may be understood that the opening signal has ceased.

A “door element” is defined as any component arranged on the motor vehicle which is pivotable or movable and can be held or fixed in a closed position by a motor vehicle lock. The closed position is the position of the door element in which the door element is held, in particular when the vehicle is being driven and, in particular, in the main closed position.

The door element can be transferred to an open position. The open position is characterized by the fact that the door element is open to such an extent that an operator of the motor vehicle can grasp the door element and open it completely. Once the motor vehicle lock has been unlocked, the door element can be moved and is no longer fixed by the motor vehicle lock. “Unlocking” refers to a locking mechanism of the motor vehicle lock and means that a pawl of the locking mechanism has been moved out of the engagement region with a catch of the locking mechanism, so that the catch can move freely.

The “release position” refers, in particular, to the state in which the catch is open to such an extent that a lock striker (which is typically fixed to a door element) is released. The “release position” can refer to a position of the door element which differs from the open position and/or lies behind the open position. The “open position” is typically the position in which the door element is in a position where an operator can grasp the door element and open it fully. The “release position” is typically the position in which the lock striker can be released from the catch.

Moving the door element into at least one release position is typically necessary to allow independent or user-guided opening of the door element.

The motor vehicle lock described here is electrically actuated. The motor vehicle provided with the motor vehicle lock is equipped, in particular, with an electrical opening function upon actuation of the motor vehicle lock. An electrical opening function is present when the locking mechanism can be moved from a ratchet position, preferably a main ratchet position, to an unratcheted position, i.e., a release position. The unratcheted position can correspond to or be equivalent to the release position. In particular, an electric drive, or an electric drive device, is provided, which moves the pawl out of engagement with the catch and thus allows electrically assisted opening of the locking mechanism, in particular to reach the unratcheted position and/or the release position.

Within the scope of the present disclosure, when referring to a motor vehicle lock, synonyms such as locking device, lock or door lock are synonymous with each other. The term “motor vehicle lock” also includes locks that are used in doors, sliding doors, hatches and/or covers in motor vehicles, i.e., wherever components that can be pivoted or moved on the vehicle must be held securely in position. A preferred feature of the motor vehicle lock according to the invention relates to a side door lock. Such motor vehicle locks comprise a locking mechanism consisting of a catch and at least one pawl, for example also two or more pawls.

The locking mechanism can be designed as a single-ratchet or double-ratchet locking mechanism. From the latest developments, locking mechanisms with rolling locking mechanism parts, such as a pivotable ratchet element, are also known. In the case of a single-ratchet locking mechanism, there is only one ratchet position in which the pawl holds the catch. In the case of double-ratchet locking mechanisms, there is, in addition to a main ratchet position, also a pre-ratchet position such that the catch and pawl can interact in two ratchet positions. In this case, a release lever interacts with the locking mechanism in such a way that the release lever disengages the caught locking mechanism. In this case, the pawl is moved out of the engagement region with the catch. It is also known to use several pawls. For example, when an opening torque for the locking mechanism occurs in the main ratchet position, the pawl can be held via a further pawl. This further pawl is then referred to as a ratchet lever or blocking lever.

A release lever can be provided, wherein the locking mechanism can be moved from a ratchet position to an open position and/or the release position by means of the release lever. The drive device can be provided or designed to actuate the release lever.

The ajar device is designed, for example, to monitor the motor vehicle lock and/or a door element with the motor vehicle lock in order to provide the ajar signal. Thus, the ajar signal may be provided when the motor vehicle lock is unlocked. For example, when the release position, the open position and/or the unratcheted position is present, the ajar signal may be present, in particular to indicate that a door element is not properly closed. The ajar device can also be assigned to the door element and/or be separate from the motor vehicle lock.

“Ajar device” or “ajar signal” or “ajar” can also be understood as a proper name. In particular, “ajar” is commonly used in the field of motor vehicle locks to indicate or imply that a door element is in an open position.

If a door element, or the motor vehicle lock, is open or not closed, i.e., the door element is in an open state or the motor vehicle lock is in a pre-ratchet position or not in main ratchet position, this is typically referred to as “AJAR” or “ajar,” where “ajar” also means “partly open” or “open.”

An advantageous development comprises generating the opening signal by user actuation of an opening device, in particular comprising a door handle, a trigger, a touchpad, a force sensor, a switch and/or a pushbutton. The opening device can be provided on a door element provided with the motor vehicle lock. For example, it can be a door handle and/or trigger or the like, which is designed to provide or generate the opening signal. The opening device can be assigned to the motor vehicle. The generating typically takes place temporally before the reversing. For example, a user can pull on the door handle and thereby generate the opening signal, at least indirectly. This allows the motor vehicle lock to be electrically actuated, and the reversing can be logically linked thereto.

A further advantageous development relates to the fact that the ajar device interacts with a locking mechanism, in particular a catch and/or a pawl of the locking mechanism, of the motor vehicle lock. The ajar device can be included in the motor vehicle lock and can interact with the locking mechanism in a sensing/detecting manner to generate the ajar signal. For example, the ajar signal can be present when the motor vehicle lock is unlocked and/or when a release position, an open position and/or an unratcheted position is present. Generation of the ajar signal by the ajar device can be provided. The ajar device can have an ajar switch, ajar pushbutton, ajar sensor and/or ajar trigger. It is advantageous here that the invention can rely on the ajar signal that is classically present in order to perform reversing. This makes it possible to omit components. It is also the case that reversing is then performed only when it actually makes sense, because when an ajar signal is present the door should in fact be open, and thus an initial position of the motor vehicle lock and/or of the drive device can advantageously already be reached again.

A further advantageous development relates to the fact that the motor vehicle lock has an electric drive device. For example, the drive device has an electric motor which is provided for rotary and/or linear drive. For example, the drive device has a control unit which is designed, for example, to control the electric motor and/or to receive and/or send signals or control commands. The electric motor is provided for moving the locking mechanism, in particular for actuating the motor vehicle lock by operating the electric motor.

The drive device preferably has a DC motor as an electric motor. A first gear element (e.g., a gear wheel, a worm, a lever and/or a rack) can be installed on an output shaft of the electric motor, which interacts with a further transmission element (e.g., a gear wheel, a worm, a lever and/or a rack) to initiate a movement in the motor vehicle lock. It is conceivable that the first gear element is in direct engagement with or is operatively connected to an actuating lever; however, at least one gear stage is preferably arranged between the driving gear element and the actuating lever. The preferred gear stage is a worm gear stage. The actuation lever can also interact directly with a/the release lever or be integrally formed as a release lever.

It is possible that receiving the opening signal and/or the ajar signal by a/the drive device of the motor vehicle lock is provided; the receiving can be performed by the control unit, for example in order to send a control command to the electric motor. In particular, the motor vehicle lock, in particular the control unit thereof, is designed to receive and/or process the opening signal and/or the ajar signal. The receiving typically takes place temporally before reversing and/or temporally after generating of opening signal.

In particular, the moving of a drive device, starting from an initial position, is provided for transferring the locking mechanism of the motor vehicle lock from a locked position to a release position. The movement is triggered, in particular, by and/or after receiving the opening signal, in particular by and/or after actuation. The moving typically takes place temporally before reversing and/or temporally after generating of opening signal. The moving typically takes place temporally after receiving the opening signal. The moving typically takes place temporally before the ajar signal is received, in particular because the moving usually has to be completed first in order to reach the ajar signal. The moving can be understood as a forward movement, while the reversing can be understood as a backward movement.

A further advantageous development relates to the fact that the motor vehicle lock, in particular the control unit, is designed to measure a (measured) time period, in particular wherein the time period can be measured with an accuracy in the range of at least one millisecond or at least ten milliseconds. In particular, the time interval between generating and/or receiving the ajar signal and generating and/or receiving the opening signal can be measured, in particular to determine whether the actuation of the motor vehicle lock, including the opening of the door element, was successful or whether a problem is indicated by the time period of the interval. Normally, the ajar signal is generated or received after the opening signal. In other words, a time delay between signals should be measurable. For example, if the time period is too long, it is possible that the door element is jammed or iced over. A short time period, in contrast, may indicate that the actuation proceeded as usual.

In particular, provision is made to measure the time period by which the generation or reception of the ajar signal is delayed relative to the generation or reception of the opening signal. As a function of the time period, the length of a control time period for which a/the moving is carried out can be determined, in particular by the control unit, wherein the measuring is performed temporally before the reversing. The control time period is therefore changed spontaneously, depending on the length of the measured time period. The control time period can refer to the total time period since receiving the opening signal or since the start of the movement, i.e., starting from “zero” from that point onward. The control time period can also refer to a time period after receiving the ajar signal, i.e., starting from “zero” from that point onward. This creates flexibility depending on the application or environmental conditions and can save energy.

In particular, the following logic regarding the measured time period can be provided. If the measured time period is less than a predetermined normal time period, then the moving is continued for an initial control time period, in particular until the initial control time period is reached. The predetermined normal time period is, in particular, 500 ms, 250 ms, 100 ms or 50 ms. The control time period is, in particular, 100 ms, 50 ms, 25 ms or 10 ms. In particular, if the measured time period is longer than the predetermined normal time period, then the moving is continued for a second control time period, in particular 400 ms, 200 ms, 100 ms or 40 ms (in particular until the second control time period is reached) or is continued until the opening signal ceases. Thus, safety can be increased and the reliability of the opening operation can be further improved, even though a sensor can in particular be omitted.

A further advantageous development relates to the fact that a/the drive device of the motor vehicle lock can be moved back, in particular to the initial position. In particular, the method can comprise moving a/the drive device back toward and/or into the initial position. Preferably, moving back takes place starting from a position that differs from the initial position. In particular, reversing comprises moving back. In particular, moving back takes place during reversing and/or is triggered by reversing. The moving back itself refers, in particular, to the movement of the drive device.

The moving back is triggered, in particular, temporally after the opening signal has ceased. The moving back is triggered, in particular, with a time delay after the opening signal has ceased. For example, when a user operates an opening device or grasps a door handle to open the door element, moving is triggered. When the user then releases the door handle or no longer actuates the opening device, the opening signal can cease and reversing can take place. The ajar signal may also have been generated in the meantime. Thus, moving back is tied in a particularly meaningful manner to a typical use case and avoids misuse.

Moving back can be triggered after receiving ajar signal. Moving back can be triggered with a time delay after receiving the ajar signal. Essentially, reversing or moving back can be triggered by the ajar signal to increase reliability and safety without requiring additional sensors for reversing or moving back.

The invention also relates to a motor vehicle which is equipped with or has a motor vehicle lock. More specifically, at least one door element of this motor vehicle can be equipped with the motor vehicle lock. The invention further relates to a motor vehicle having the motor vehicle lock, wherein this motor vehicle is configured to carry out the method described herein.

The invention is explained in more detail below with reference to the accompanying drawings and sketches. However, the principle applies that the exemplary embodiment does not limit the invention, but is merely an advantageous design. The features depicted can be implemented individually or in combination with further features of the description as well as the claims—individually or in combination.

In the figures:

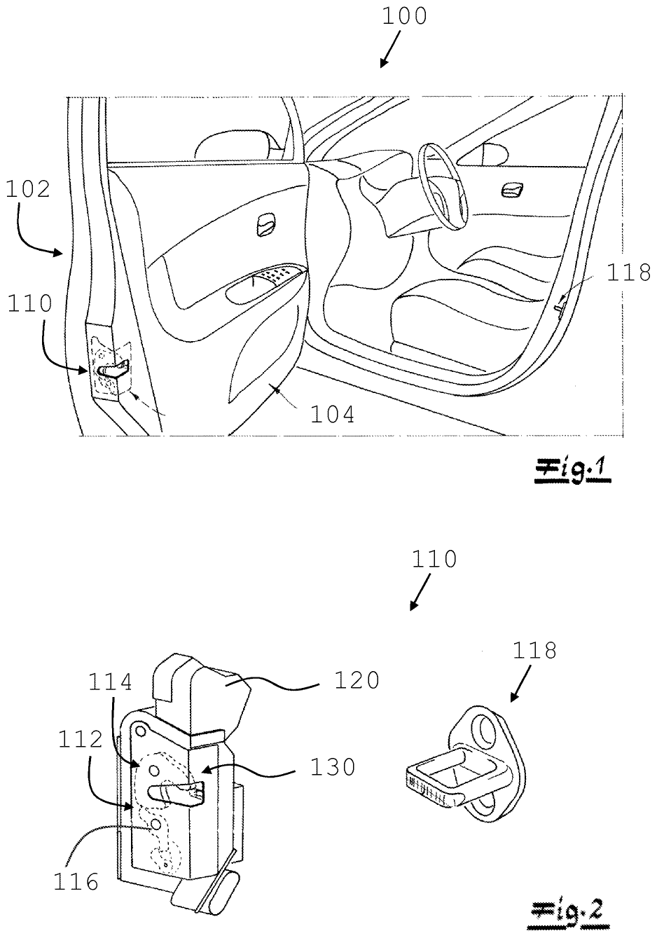

FIG. 1 shows a perspective representation of a door element of a motor vehicle equipped with a motor vehicle lock,

FIG. 2 shows a perspective representation of the motor vehicle lock of FIG. 1 together with a lock striker, and

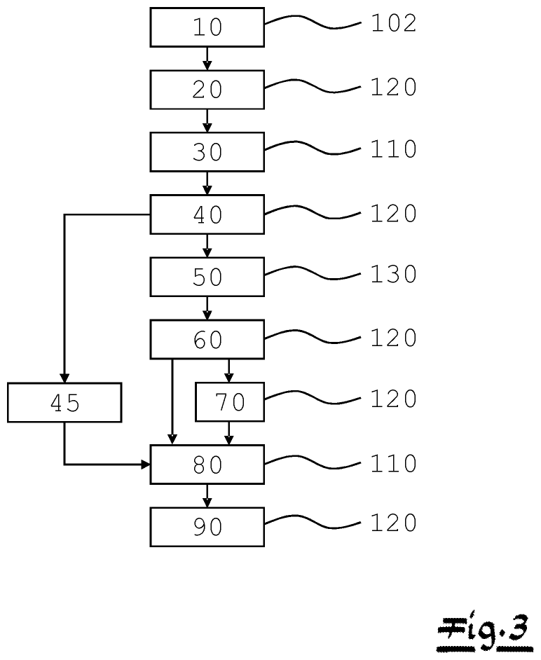

FIG. 3 shows schematic representation of a method for operating the motor vehicle lock of FIG. 1.

FIG. 1 shows a motor vehicle 100 in which a door element 104 is arranged in an open position. The door element 104 has an opening device 102 having a door handle to provide an opening signal when a user grasps the door handle and pulls on it to open the door element 104. The motor vehicle 100 has a lock striker 118 on a B-pillar, which corresponds to a motor vehicle lock 110 arranged in the door element 104. The lock striker can be fixed by the motor vehicle lock 110 when the door element 104 is closed or held in a main locked position, which is not shown. The motor vehicle lock 110 is in a release position.

It can be seen from FIG. 2 that the motor vehicle lock 110 has a locking mechanism 112 having a catch 114 and a single pawl 116. It is conceivable that a plurality of pawls are provided, for example to achieve a plurality of ratchet positions of a catch (not shown).

The pawl 116 is provided for locking the catch 114 in a locked position of the locking mechanism 112. Furthermore, an electromechanical drive device 120 is provided which is operatively connected to the locking mechanism 112 and can be moved starting from an initial position. The drive device 120 can move the motor vehicle lock 110, or the locking mechanism 112, between the locked position and the release position. For this purpose, the drive device 120, more specifically a control unit, can receive the opening signal from the opening device 102. The motor vehicle lock 110 also has an ajar device 130 which can provide an ajar signal.

The drive device 120 is designed to reverse to the initial position depending on the opening signal having ceased and/or the ajar signal being received.

FIG. 3 shows a method according to the invention, which is carried out with the motor vehicle lock 110 shown in FIGS. 1 and 2.

First, the opening signal is generated 10 at the opening device 102. A user grasps the door handle, whereupon the opening signal is provided.

The opening signal is then received by the drive device 120, more specifically by the control unit, in step 20. The drive device 120, or control unit, then causes the motor vehicle lock 110 to be actuated 30. More precisely, upon actuation 30, the control unit operates the electric motor. At the same time, the moving 40 of the drive device 120 takes place. The moving 40 takes place starting from an initial position to transfer a locking mechanism 112 from a locked position to a release position, wherein the moving 40 is triggered by, or after, receiving 20 the opening signal, and by, or after, the actuation 30.

It is now only a matter of time before the ajar signal is generated in step 50, specifically by the ajar device 130. This is usually the case when the catch 114 releases the lock striker 118, because the catch 114 then actuates a switch or pushbutton on the ajar device 130.

The ajar signal can be received by the drive device 120 in the step of receiving 60. In this case, after receiving 60, the step of measuring 70 is performed, in which the time period between the steps receiving 20 and receiving 60 is measured. As a function of the measured time period, the length of a control time period is determined for which the moving 40 will continue to be carried out.

If the measured time period is less than a predetermined normal time period of 50 ms, then the moving 40 is continued for an initial control time period of 10 ms. If the measured time period is longer than the predetermined normal time period of 50 ms, then the moving 40 is continued for a second control time period of 40 ms or is continued until the opening signal has ceased in step 45.

Furthermore, after the start of the step of moving 40, it is only a matter of time before the opening signal ceases 45 or has its desired effect. The cessation 45 takes place, for example, when the user releases the door handle. The cessation 45 takes place during or after moving 40 and/or generating 50 and/or receiving 60 and/or measuring 70.

Finally, reversing 80 is triggered in the motor vehicle lock 110. In the present case, the reversing 80 takes place depending on the cessation 45 and the receiving 60. The reversing 80 also implies that the drive device 120 is immediately moved (back) in the step of moving back 90 to reach its initial position. In the present case, the reversing takes place according to steps 10, 20, 30, 40, 45, 50, 60, 70. The moving back takes place starting from a position that differs from the initial position.

In the present case, the moving back 90 is triggered temporally after the cessation 45 of the opening signal, more specifically immediately upon and/or by the cessation 45. The moving back 90 can alternatively or additionally be triggered after receiving 60 the ajar signal, particularly preferably with a time delay after receiving 60 the ajar signal.

The steps of generating 10 and receiving 20 may take place substantially simultaneously. The steps of generating 50 and receiving 60 may take place substantially simultaneously. Here, as the delay between generating 10 or 20 and receiving 20 or 60, essentially the signal path is considered.

### LIST OF REFERENCE SIGNS

10 Generating the opening signal
20 Receiving the opening signal
30 Actuating
40 Moving
45 Cessation of the opening signal
50 Generating the ajar signal
60 Receiving the ajar signal
70 Measuring the time period
80 Reversing
90 Moving back
100 Motor vehicle
102 Opening device
104 Door element
110 Motor vehicle lock
112 Locking mechanism
114 Catch
116 Pawl
118 Lock striker
120 Drive device
130 Ajar device

1. A method for operating a motor vehicle lock which can be electrically actuated by means of an opening signal, comprising
reversing the motor vehicle lock after an actuation of the motor vehicle lock, wherein the reversing is carried out depending on the opening signal having ceased and/or an ajar signal being received from an ajar device of the motor vehicle lock.

2. The method according to claim 1, comprising
generating the opening signal by user actuation of an opening device, in particular comprising a door handle, a trigger, a touchpad, a force sensor, a switch and/or a pushbutton.

3. The method according to claim 1, comprising generating the ajar signal by means of the ajar device interacting with a locking mechanism, in particular a catch and/or a pawl of the locking mechanism, of the motor vehicle lock, in particular comprising an ajar switch, ajar pushbutton, ajar sensor and/or ajar trigger.

4. The method according to claim 1, comprising receiving the opening signal and/or the ajar signal from a drive device of the motor vehicle lock.

5. The method according to claim 1, comprising moving a/the drive device, starting from an initial position, to transfer a locking mechanism of the motor vehicle lock from a locked position to a release position, in particular the moving being triggered by and/or after receiving the opening signal, in particular by and/or after actuation.

6. The method according to claim 5, comprising
measuring a time period by which the reception of the ajar signal is delayed relative to the reception of the opening signal, wherein the length of a control time period is determined, as a function of the measured time period, for which the moving is performed, wherein the measuring is performed temporally before the reversing.

7. The method according to claim 6, wherein
if the measured time period is less than a predetermined normal time period, in particular 500 ms, 250 ms, 100 ms or 50 ms, then the moving is continued for a first control time period, in particular 100 ms, 50 ms, 25 ms or 10 ms; and
if the measured time period is longer than the predetermined normal time period, then the moving is continued for a second control time period, in particular 400 ms, 200 ms, 100 ms or 40 ms, or is continued until the opening signal ceases.

8. The method according to claim 1, the reversing comprising
moving back a/the drive device toward and/or into the initial position, in particular wherein the moving back takes place starting from a position different from the initial position.

9. The method according to claim 8, wherein the moving back is triggered temporally after the opening signal has ceased and, in particular, is triggered with a time delay after the opening signal has ceased.

10. The method according to claim 8, wherein the moving back is triggered temporally after the reception of the ajar signal and, in particular, is triggered with a time delay after the reception of the ajar signal.

11. A motor vehicle lock, comprising a locking mechanism having a catch and a pawl provided for locking the catch in a locked position of the locking mechanism and an electromechanical drive device which is operatively connected to the locking mechanism and movable, starting from an initial position, to transfer the locking mechanism from the locked position to a release position on the basis of an opening signal, wherein the drive device is designed to reverse to the initial position depending on the opening signal having ceased of and/or an ajar signal being received from an ajar device of the motor vehicle lock.
